(19) United States
(12) Patent Application Publication
(10) Pub. No.: US 2019/0085597 A1
(43) Pub. Date: Mar. 21, 2019

(54) LOCK FOR CONTAINERS OF VALUABLES

(71) Applicant: Carl Wittkopp GmbH, Velbert (DE)

(72) Inventors: Jörg Naumann, Velbert (DE); Kubilay Dervisoglu, Velbert (DE)

(73) Assignee: Carl Wittkopp GmbH, Velbert (DE)

(21) Appl. No.: 15/708,308

(22) Filed: Sep. 19, 2017

(51) Int. Cl. E05B 47/06; E05B 63/06; E05B 65/00

(52) U.S. Cl. CPC E05B 47/0607; E05B 63/0056; E05B 65/0075; E05B 63/06

(57) ABSTRACT

A lock for valuables containers which can be used with a structure as simple as possible in different types of bolt mechanisms, in particular also in scissors bolt mechanisms.

### BACKGROUND OF THE INVENTION

### Field of the Invention

The invention relates to a lock for a container of valuables, in particular for the door of a cash dispenser or a safe, with a housing, with a bolt, with a blocking element and with a spring element, the bolt being located to be able to move in the housing between a blocking position which is extended out of the housing and an open position which is retracted into the housing parallel to the longitudinal axis of the housing and the bolt being lockable in the blocking position by means of the blocking element, and the spring element applying a force to the bolt which pushes the bolt in the direction of the blocking position.

### Description of Related Art

In the locks under discussion here, which are also called security locks, the bolt is not used directly to lock the door of the valuables container which is to be secured, but to lock a bolt mechanism. The bolt mechanism is attached to the inner side of the door of the corresponding valuables container, for example, a cash dispenser, a safe or a strong room in order to protect the door in the closed and locked state against unauthorized opening. The mechanical bolt mechanism interacts with the lock which is generally screwed for this purpose on the base plate of the bolt mechanism. Locks which are used for this application can be fundamentally both mechanical and also electronic locks, but bolt mechanisms which are to meet increased security requirements being in general combined with electronic locks which generally are locked and unlocked via an alphanumeric input unit.

In the locked state of the bolt mechanism, there are one or two bolts of the bolt mechanism in a first, extended closed position, a movement of the bolt or bolts back into the second, retracted opening position being prevented by the bolts laterally adjoining the extended bolt of the lock. For intentional opening of the bolt mechanism, therefore the lock must first be unlocked and the bolt of the lock must be pulled back out of its blocking position so that the bolt or bolts of the bolt mechanism are no longer blocked by the bolt of the lock. The bolt of the bolt mechanism can be shifted out of its first extended position into its second retracted position by actuating a handle which is located on the outside of the door of the valuables container so that the door can be unlocked and opened afterwards.

If the door is to be locked again, after closing the door, the bolt mechanism must first be moved by a corresponding actuation of the handle out of its second position back into its first position. Afterwards, in addition the lock must still be locked so that the bolt of the lock is returned to its locked position in which the bolt of the lock interacts with the bolt or bolts of the bolt mechanism. The effort for locking the door is increased by the lock having to be locked in addition for locking of the bolt mechanism.

Fundamentally, two different types of locks are known, specifically “solid bolt locks” and “swingbolt locks” or “rotobolt locks”. Solid bolt locks have a rectangular bolt which can be displaced linearly and which is generally moved by means of an electric motor out of its blocking position which is extended out of the housing into the open position which is retracted into the housing. If the lock has an electric motor, the bolt of the lock is generally also moved by the electric motor out of the second opened position into the extended blocking position.

Instead of a linearly movable bolt, swingbolt locks have a pivotally mounted swingbolt which when the lock is unlocked is swiveled back into the housing by the bolt of the bolt mechanism which has been shifted in the direction of the opening position. Thus in swingbolt locks the use of an electric motor for retracting the bolt into the housing can be omitted. Via a spring which is located in the housing of the lock the swingbolt is exposed to a force which automatically swivels the swingbolt back into its blocking position, when the swingbolt is released, i.e. when the bolt mechanism has been moved beforehand into its first extended blocking position. Swingbolt locks are thus both self-closing and also self-opening, a user having to lock or unlock the lock only by inputting a corresponding code so that the actuation of a bolt mechanism is simplified accordingly.

One disadvantage of swingbolt locks is however that they can only be used in bolt mechanisms with one bolt, since based on the shape and the arrangement of the swingbolt they can block only on one side against the direction of movement of the swingbolt. Conversely, if a scissors bolt mechanism which has two bolts which move towards one another for opening of the bolt mechanism is to be used as the bolt mechanism, locks with swingbolts cannot be used. In scissors bolt mechanisms therefore solid bolt locks are always used which are connected to the bolt mechanism such that the bolt of the lock in the blocked state is located between the two bolts or scissors of the scissors bolt mechanism, as a result of which movement of the bolts of the bolt mechanism towards one another is prevented by the bolt of the lock.

### SUMMARY OF THE INVENTION

Therefore, the object of this invention is to provide a lock for valuables containers which can be used with a structure as simple as possible in different types of bolt mechanisms, in particular also in scissors bolt mechanisms.

This object is achieved in the initially described lock in that the bolt on its end protruding out of the housing has two bevels which each run at an angle a to the direction in which the bolt moves. In contrast to a solid bolt, in the lock in accordance with the invention the end of the bolt protruding out of the housing is thus not made rectangular, but depending on the configuration of the bevels has a roughly trapezoidal surface area. In this way the side surfaces of the bolt are not located perpendicular to the direction of movement of the bolts or scissors of the bolt mechanism, but at an angle less than 90° so that by the opening motion of the bolt mechanism a force acts on the bolt of the lock by which the bolt is moved into its open position when the lock has been unlocked.

Since in the lock in accordance with the invention the shape of the end of the bolt which is protruding out of the housing, in contrast to the shape of a swingbolt, is not quadrant-shaped and the bolt is not pivotally mounted in the housing either, the lock in accordance with the invention can also be used in scissors bolt mechanisms in which two bolts or scissors act from two opposite sides on the bolt of the lock so that the lock can be used in a very versatile manner.

Preferably, the angle a of the bevel relative to the direction in which the bolt moves is roughly 45°, but even smaller deviations therefrom being fundamentally possible. The angle a of the bevels to the direction of motion should however generally be between 35° and 55°, in particular between 40° and 50°, and the angle a of the two bevels should be the same in order to avoid canting of the bolt when pushed into the housing.

According to one advantageous configuration of the lock in accordance with the invention, the bolt is made in at least two parts, having a bolt head and a bolt shaft which are detachably joined to one another. In this way, the manufacture of the bolt can be simplified, and it is possible to combine a bolt shaft with different bolt heads which differ, for example, by somewhat different angles of the bevels. Likewise, of course, one bolt head can also be joined to different bolt shafts which can be adapted to different housing sizes. The bolt head and bolt shaft are joined preferably via a screw, as a result of which secure joining of the bolt head and bolt shaft as well as simple replacement of one of the two components are enabled. Thus, it is, for example, also possible to simply replace a damaged bolt head without having to replace the entire bolt or even the entire lock. Finally, the two-part execution of the bolt makes it possible to use different materials for the bolt head and the bolt shaft so that for the bolt head which is exposed to higher mechanical stress a harder material, for example, a precision steel casting, than for the bolt shaft can be used.

In order to ensure secure fastening of the bolt head to the bolt shaft, and in particular to prevent twisting or tilting of the bolt head relative to the bolt shaft, the bolt head according to one preferred configuration has a pocket-like recess into which the end of the bolt shaft protruding out of the housing is inserted. The end of the bolt shaft is thus surrounded by the bolt head in the manner of a hood. The free end of the bolt shaft is thus preferably matched in its shape to the shape of the bolt head so that the free end of the bolt shaft preferably also has a trapezoidal surface area.

As has already been stated above, the mechanical joining of the bolt head and bolt shaft takes place preferably by means of a screw, for which a hole for the screw is made in the bolt head and extends on either side of the recess, i.e., the hole does not end in or on the recess, but continues after the recess in the bolt head. In the end of the bolt shaft which has been inserted into the recess an elongated opening is moreover made, the hole and the elongated opening being arranged to one another such that a screw which has been screwed into the hole penetrates the opening in the bolt shaft. If an elongated opening whose longitudinal extension is greater than the diameter of the screw is formed in the end of the bolt shaft which has been inserted into the recess, it is possible to change the position of the bolt head relative to the bolt shaft in the longitudinal direction of the opening and thus also in the direction in which the bolt moves. This easily makes it possible to adjust the bolt stroke of the lock bolt, as a result of which freewheeling of the bolts of the bolt mechanism which may otherwise be present based on the bevels on the end of the bolt can be compensated.

The above described variability of the position of the bolt head relative to the bolt shaft and thus the adjustability of the bolt stroke moreover enable the lock to be easily adapted to an individual bolt mechanism, as a result of which in particular it also becomes possible to replace a lock used for a scissors bolt mechanism with a solid bolt by a lock in accordance with the invention.

The bolt stroke can be adjusted according to one especially preferred configuration of the invention in that, in the region of the recess in the bolt head, there is a fixing element which has one, preferably two wedge-shaped clamping surfaces and a hole, the fixing element being arranged such that the screw engages the hole. In the elongated opening in the bolt shaft, at least one corresponding counter-clamping surface is formed such that with the screw tightened the clamping surface of the fixing element and the counter-clamping surface interact such that the bolt head is fixed relative to the bolt shaft. Loosening of the screw conversely leads to the clamping surface and the counter-clamping surface having a short distance to one another and thus no longer interacting so that the bolt head can be moved relative to the bolt shaft in the direction of movement of the bolt.

The fixing element which, as stated above, has preferably two clamping surfaces opposite one another can consist both of metal and also of an elastic material. The clamping surfaces preferably have several ribs to which on the counter-clamping surfaces ribs corresponding to the opening in the bolt shaft are made. In this way the bolt head is secured especially reliably against moving or slipping in the direction of movement of the bolt even if a force is acting on the bevels of the bolt head.

The lock can be adapted to the respective bolt mechanism and in particular the freewheeling of the scissors of a scissors bolt mechanism can moreover also be compensated by the position of the lock relative to the bolts or scissors of the bolt mechanism being adjustable. For this purpose, according to one preferred configuration of the invention it is provided that the attachment openings which are made in the lock housing and through which the lock is fastened by means of corresponding screws to a base plate of the bolt mechanism are made as slots. Even if the holes in the base plate of the bolt mechanism which correspond to the attachment openings in the housing of the lock are stipulated, adaptation of the exact position of the lock and in particular of the lock bolt relative to the bolts or scissors of the bolt mechanism is thus possible. This type of adaptation of the lock to the respective bolt mechanism is used in particular when the bolt is made in one piece, therefore is not formed of a bolt head and a bolt shaft which are detachably joined to one another.

According to one preferred configuration of this adjustment possibility of the lock position, the edge region of the housing surrounding the attachment openings has several ribs, as a result of which the attachment of the lock is enhanced and the risk of slippage of the lock under a force acting on the bevels of the bolt head is reduced. In addition, plain washers or lock washers with ribs can be used which further increase the security of the attachment of the lock and at the same time are also used as screw protection.

In particular, at this point there is a host of possibilities for configuring and developing the lock in accordance with the invention as will be apparent from the following description of preferred exemplary embodiments of the invention in conjunction with the accompanying drawings.

### BRIEF DESCRIPTION OF THE DRAWINGS

FIGS. 1a-1c show a simplified schematic of a solid bolt lock, a swingbolt lock and a lock in accordance with the invention respectively,

FIG. 2 shows one embodiment of a lock in accordance with the invention with the housing cover removed,

FIG. 3 is a perspective view of the bolt of the lock,

FIG. 4 shows the bolt according to FIG. 3 in a longitudinal sectional view,

FIGS. 5a & 5b are enlarged views of the bolt head, from underneath and in a section, respectively,

FIG. 6 is a top view of the bolt shaft Of the bolt according to FIG. 3,

FIG. 7 is a longitudinal section of the bolt shaft according to FIG. 6,

FIGS. 8a & 8b are enlarged views of a fixing element, from underneath and from the side, respectively

FIG. 9 is a plan view of a lock attached to a bolt mechanism, in the basic position,

FIG. 10 shows an enlarged cutout of the lock and of the bolt mechanism according to FIG. 9,

FIG. 11 shows the cutout of the lock and of the bolt mechanism according to FIG. 10, after completed compensation of the freewheeling,

FIG. 12 shows the cutout of the lock and of the bolt mechanism according to FIG. 10, in the half-opened state of the bolt mechanism, and

FIG. 13 shows an alternative configuration of a lock from the bottom.

### DETAILED DESCRIPTION OF THE INVENTION

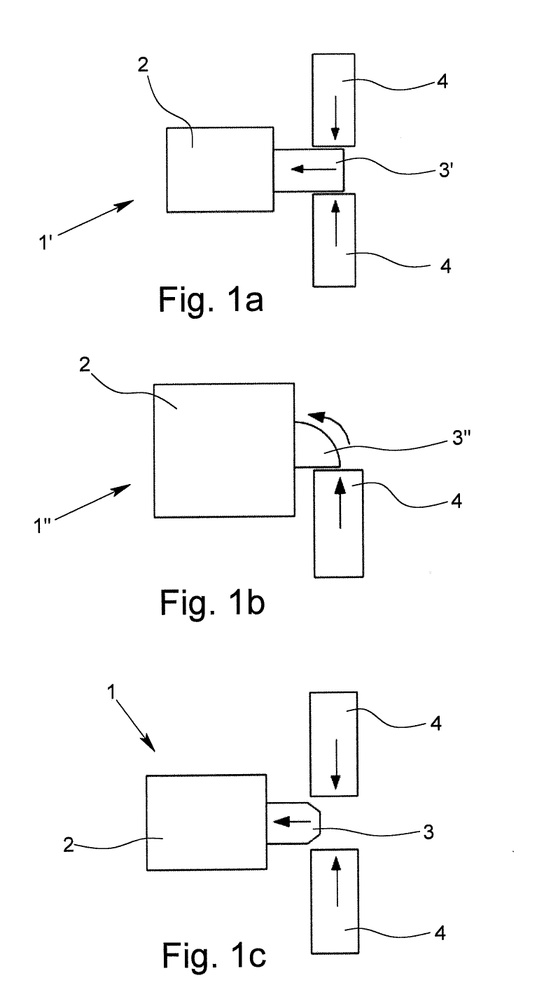

FIGS. 1a-1c show three simplified schematics of a lock 1, of the lock 1 only the housing 2 and the bolt 3 in the extended blocking position being shown. In the lock 1′ which is shown in FIG. 1a, the bolt 3′ is made as a solid bolt whose end which is protruding out of the housing 2 has a rectangular surface area. FIG. 1b conversely shows a swingbolt lock 1″ in which the bolt 3″ is made as a swingbolt which is pivotally mounted in the housing 2 and whose end which is protruding out of the housing 2 is made quadrant-shaped. FIG. 1c finally shows a lock 1 in accordance with the invention with a specially made bolt 3 which is explained in greater detail below.

In addition to the lock 1, in the three illustrations according to FIG. 1a-1c, two or one bolt 4 of a bolt mechanism are shown. As is apparent from FIG. 1a, the solid bolt lock 1′ shown there is suited to preventing a movement of the two bolts 4 of the bolt mechanism towards one another when the bolt 3′ is in its blocking position which is extended out of the housing 2. For intentional opening of the bolt mechanism first the lock 1′ must be unlocked, the bolt 3′ of the lock 1′ having to be actively retracted out of its extended blocking position, for example, by means of an electric motor, into the housing 2.

The swingbolt lock 1″ which is shown in FIG. 1b is conversely suited only for blocking an individual bolt 4 of a bolt mechanism so that such a swingbolt lock 1″ cannot be used in scissors bolt mechanisms. For this reason, the swingbolt lock 1″ has the advantage that the bolt 3″ of the lock 1″ with the lock 1″ unlocked can be swung into the housing 2 of the lock 1″ by the motion of the bolt 4 of the bolt mechanism so that the bolt 3″ itself need not be actively moved out of the extended or swung-out blocking position into the open position which has been swung or retracted into the housing 2.

The lock 1 in accordance with the invention which is shown in FIG. 1c combines the two advantages of the above described two locks 1′, 1″. As is apparent from FIG. 1c, it can be used like a solid bolt lock also in scissors bolt mechanisms with two bolts 4. As in a swingbolt lock, the bolt 3 of the lock 1 with the lock 1 unlocked however need not be additionally moved actively out of the extended blocking position into the retracted open position, since here too the force which is required for this purpose is applied by the bolts 4 of the bolt mechanism when the bolt mechanism is being opened.

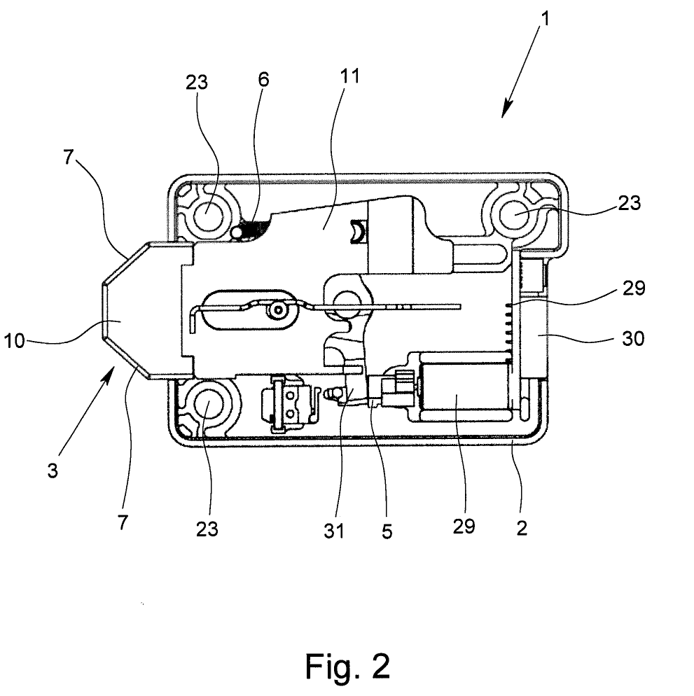

FIG. 2 shows one preferred embodiment of the lock 1 in accordance with the invention in which in addition to the above named bolt 3 there are at least another blocking element 5 and a spring element 6 in the housing 2. The blocking element 5 is used to lock the bolt 3 in the illustrated blocking position so that the bolt 3 cannot be pushed into the housing 2 even if a corresponding force is acting on the bolt 3 from the outside. Conversely, the spring element 6 is used to apply a force to the bolt 3, which force pushes the bolt 3 in the direction of the blocking position so that the bolt 3 is moved automatically out of the open position parallel to the longitudinal axis of the housing 2 into its extended blocking position if the path of the bolt 3 is not being blocked by a bolt 4 of a bolt mechanism.

As is apparent from FIG. 2 and also from a comparison of FIG. 1c in particular to FIG. 1a, the bolt 3 on its end protruding out of the housing 2 has two bevels 7 which are each located at an angle a of 45° relative to the direction of movement of the bolt 3. This leads to a force which acts from the bolts 4 of the bolt mechanism on the bevels 7 of the bolt 3 of the lock 1 pushing the bolt 3 out of its blocking position into the housing 2 when a bolt mechanism is being opened if beforehand the blocking element 5 has been moved by unlocking of the lock 1 into a position in which the blocking element 5 enables a corresponding movement of the bolt 3 into the housing 2. In doing so, the bolt 3 need not be fully retracted into the housing 2, but only to the extent that the bolt 3 no longer inhibits the intended motion of the bolts 4 of the bolt mechanism. The lock 1 which is shown in FIG. 2 is normally closed with a housing cover which is not shown here when it is being attached to a bolt mechanism 8. For this purpose, the lock 1 according to FIG. 1 is screwed to the housing cover downward on a base plate 9 of the bolt mechanism.

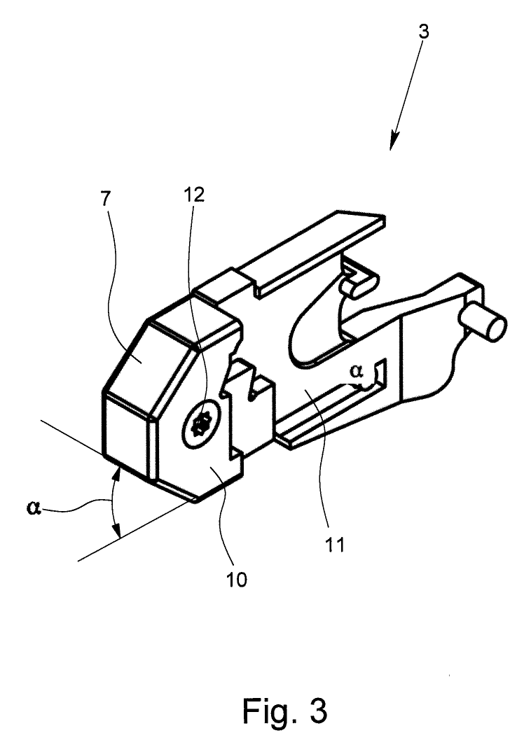

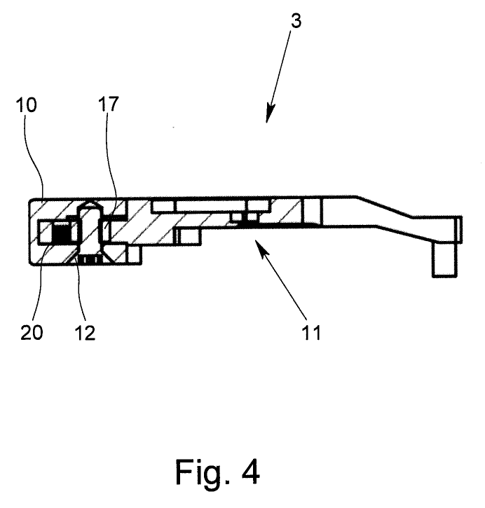

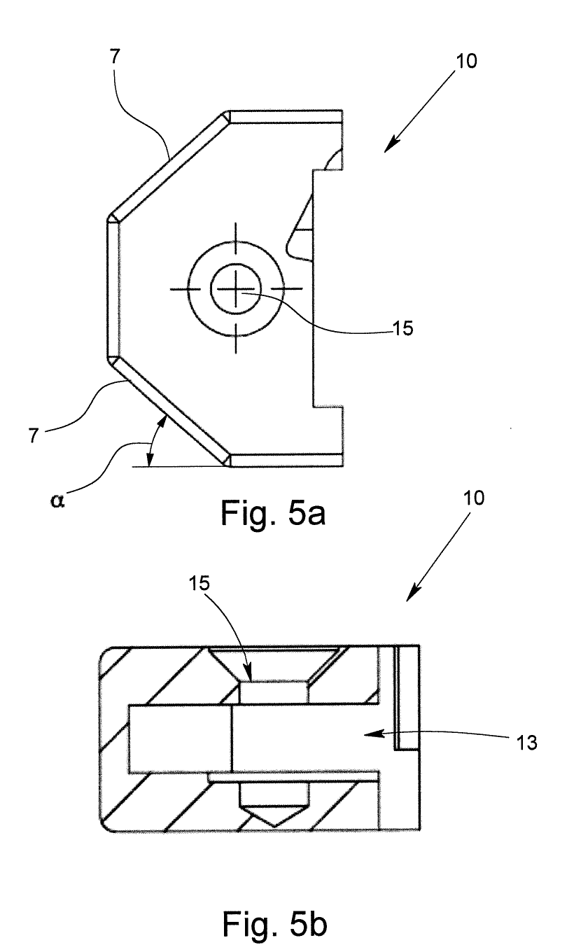

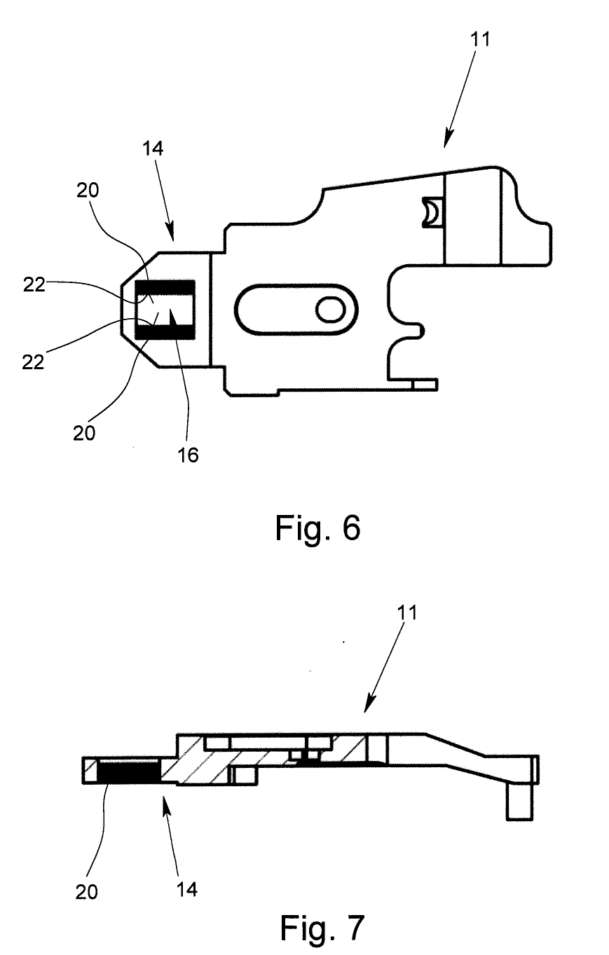

FIGS. 3 and 4 show the bolt 3 of the lock according to FIG. 2 in a perspective (FIG. 3) and in a longitudinal section (4). FIG. 3 shows the bolt 3, compared to the illustration according to FIG. 2, from the bottom, while in the plan view of the lock 1 according to FIG. 2 the top of the bolt 3 which is facing the base plate 9 in the state mounted on the base plate 9 of the bolt mechanism 8 is visible. The bolt 3 is comprised of a bolt head 10 and a bolt shaft 11 which are joined to one another via a screw 12. As is apparent from FIG. 3, the bevels 7 are made on the bolt head 10 which is shown separately in FIGS. 5a & 5b. Conversely, in FIGS. 6 and 7, the bolt shaft 11 is shown without the bolt head 10.

As is apparent in particular from FIG. 4 and from FIG. 5b, the bolt head 10 has a pocket-like recess 13 into which the end 14 of the bolt shaft 11 protruding out of the housing 2 is inserted. Moreover, a hole 15 for the screw 12 is made in the bolt head 10 and extends on either side of the recess 13. In the end 14 of the bolt shaft 11 which has been inserted into the recess 13 an elongated opening 16 is made through which the screw 12 extends in the mounted state of the bolt head 10 and bolt shaft 11.

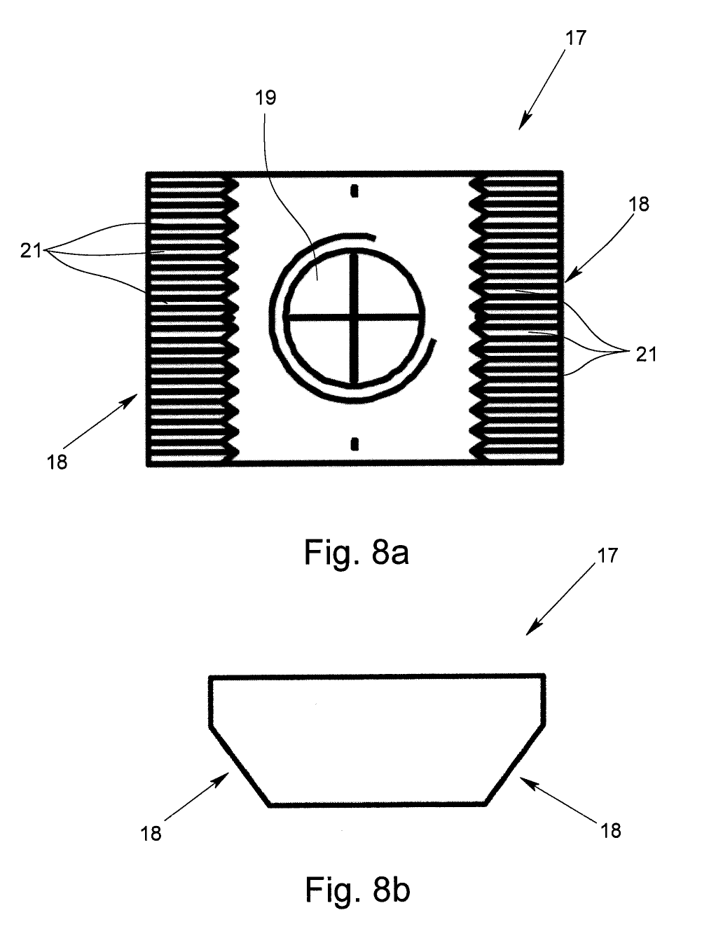

Since the length of the opening 16 is much greater than the diameter of the hole 15 or of the screw 12, it is possible to shift the bolt head 10 relative to the bolt shaft 11 in the longitudinal direction of the opening 16, and thus, also in the direction in which the bolt 3 moves, as a result of which the bolt stroke of the bolt 3 can be adjusted. To do this, in the region of the recess 13 in the bolt head 10 there is a fixing element 17 which is shown separately in FIGS. 8a & 8b. The fixing element 17 has two wedge-shaped clamping surfaces 18 and a hole 19 into which the screw 12 is screwed, for which the hole 19 has a thread which corresponds to the screw 12.

As is apparent from FIG. 8b, the fixing element 17 has a trapezoidal outline which is matched to the outline of the elongated opening 16 in the end 14 of the bolt shaft 11. The elongated opening 16 housing specifically two counter-clamping surfaces 20 so that the bolt head 10 can be fixed in the longitudinal direction of the opening 16 via the clamping surfaces 18 and the counter-clamping surfaces 20. When the screw 12 has been tightened, the clamping surfaces 18 interact with the counter-clamping surfaces 20 such that the bolt head 10 is fixed relative to the bolt shaft 11. In order to then also avoid shifting of the bolt head 10 in the longitudinal direction of the opening 16, when a corresponding force is acting on the bolt head 10, for example, because the bolts 4 of a bolt mechanism 8 are pressing against the bevels 7 of the bolt head 10, several ribs 21, 22 are made both on the clamping surfaces 18 and also on the counter-clamping surfaces 20. When the screw 12 has been tightened, then the ribs 21 of the clamping surfaces 18 of the fixing element 17 engage the ribs 22 of the counter-clamping surface 20. When the screw 12 is loosened, this leads to the ribs 21 of the clamping surfaces 18 no longer engage the ribs 22 of the counter-clamping surfaces 20 so that the bolt head 10 with the screw 12 and the fixing element 17 which has been penetrated by the screw 12 can be shifted within the elongated opening 16 in the bolt shaft 11. For this reason, the extension of the fixing element 17 in the longitudinal direction of the opening 16 is less than the longitudinal extension of the opening 16.

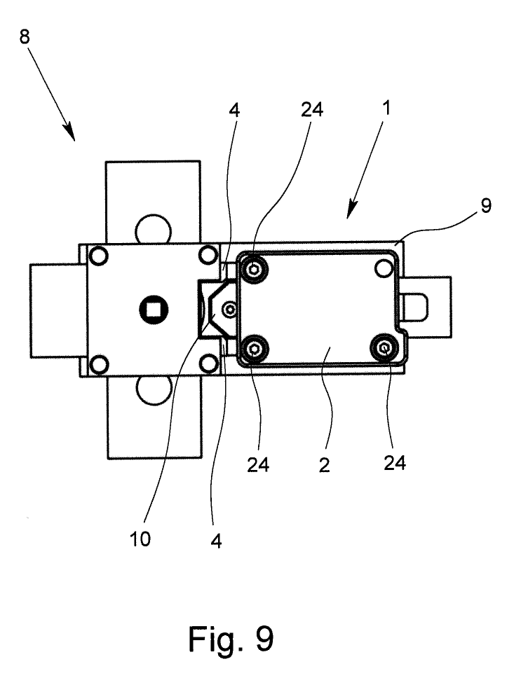

FIG. 9 shows a plan view of the lock 1 according to FIG. 2, the lock 1 being screwed on a base plate 9 of a bolt mechanism 8. Compared to FIG. 2, in FIG. 9 the lock 1 is shown from the bottom. So that the lock 1 can be attached to the base plate 9 of the bolt mechanism 8, in the housing 2 of the lock 1 a total of three attachment openings 23 are made through which screws 24 are screwed into the base plate 9. In the illustration of the lock 1 which is shown in FIG. 9 there is a bolt 3 in its blocking position which has been extended out of the housing 2, the bolt head 10 however not being set exactly to the position of the bolts 4 of the bolt mechanism 8.

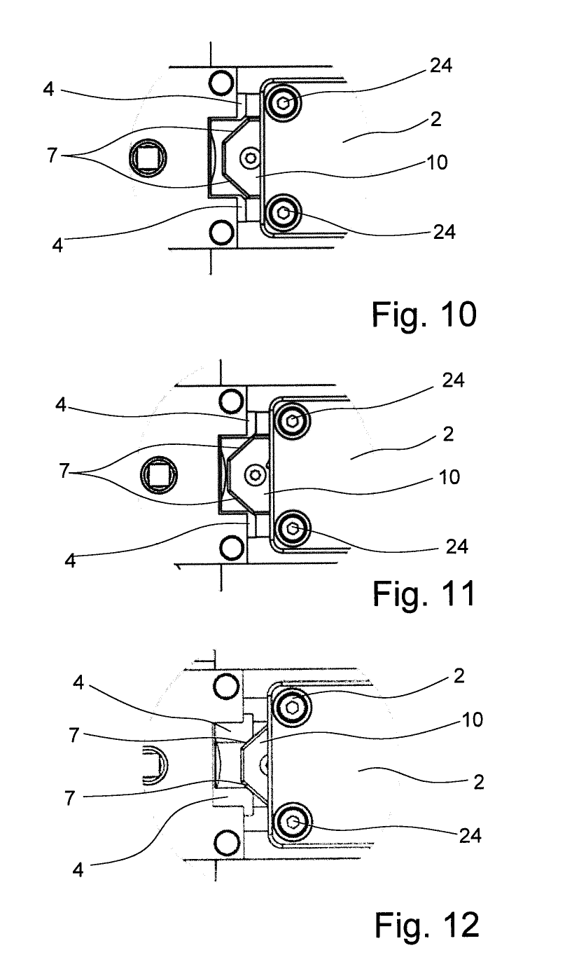

As is apparent from the enlarged representation according to FIG. 10, there is still a short distance between the bevels 7 of the bolt head 10 and the corresponding surfaces of the bolts 4 of the bolt mechanism 8. By adjusting the bolt stroke, this freewheeling can be compensated so that the bolts 4 of the bolt mechanism 8 in the blocked state directly adjoin the bevels 7 of the bolt head 10, as is shown in FIG. 11. If at this point the lock 11 is being unlocked, for example, by inputting a certain code by means of a corresponding input device, the bolt mechanism 8 can be unlocked so that the two scissors or bolts 4 of the scissors bolt mechanism 8 move towards one another, as is apparent from FIG. 12. By the movement of the bolts 4 perpendicular to the direction of movement of the bolt 3, the bolt 3 of the lock 1 is pushed into the housing 2 until the bolts 4 of the bolt mechanism 8 can be routed past the front of the bolt 3, i.e. the bolt 3 no longer prevents opening of the bolt mechanism 8. The direction in which the bolt 3 moves is parallel to the longitudinal axis of the housing 2 and thus perpendicular to the front of the housing 2 in which an opening is formed for the bolt head 10.

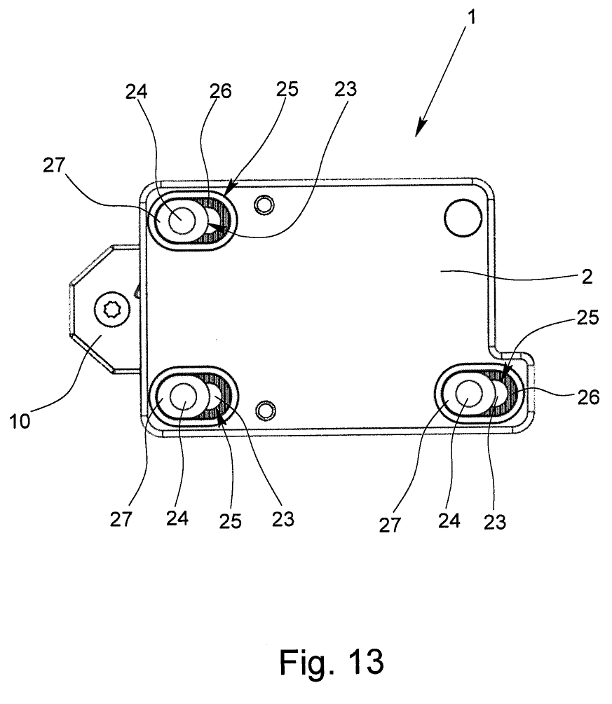

FIG. 13 shows a somewhat different embodiment of the lock 1, the lock 1 being shown from the bottom as in FIG. 9. Here, the exact positioning of the bolt head 10 relative to the stop surfaces of the bolts 4 of the bolt mechanism 8 can proceed by way of the position of the housing 2 being able to be altered. To do this, the attachment openings 23 in the housing 2 are made as slots so that even when the holes in the base plate 9 of the bolt mechanism 8 have been permanently set at a certain displacement of the housing 2, and thus, also of the bolt 3 in the direction of movement of the bolt 3 is possible. The edge region 25 of the housing 2 which surrounds the attachment openings 23 has several ribs 26, as a result of which the risk of slipping of the housing 2 is reduced when a force is acting on the bevels 7 of the bolt 3. According to the preferred configuration moreover plain washers 27 are also still being used which likewise have corresponding ribs on the side facing the housing 2.

In the illustration of the lock 1 according to FIG. 2, other parts which are located in the housing 2 are shown which are of subordinate importance to this invention, and thus, need not necessarily be implemented. To actuate the pivotally mounted blocking element 5, there is, for example, an electric motor 28 in the housing 2 which is connected via a circuit board 29 to a control 30. Here, rotation of the blocking element 5 by a relatively small angle is sufficient to move the blocking element 5 out of the illustrated blocking position into a position which releases the bolt 3. Moreover, between the bolt 3 and the blocking element 5, there is a lever element 31 which can be pivoted around a pin which is located in the housing 2.

What is claimed is:

1. A lock for containers of valuables, to lock a bolt mechanism, which is attached to the inner side of the door of the container of valuables, comprising:
a housing,
a bolt that is movable in the housing between a blocking position which is extended out of the housing and an open position which is retracted into the housing parallel to a longitudinal axis of the housing,
a blocking element, the bolt being lockable in the blocking position by means of the blocking element, and
a spring element arranged in the housing in a manner applying a force to the bolt in a direction toward the blocking position,
wherein an end of the bolt that protrudes out of the housing has a trapezoidal surface area with two bevels, each of the bevels running at an angle relative to a direction in which the bolt is movable, and wherein both bevels have the same angle.

2. The lock in accordance with claim 1, wherein the angle of the bevels is between 35° and 55°.

3. The lock in accordance with claim 1, wherein the angle of the bevels is between between 40° and 50°.

4. The lock in accordance with claim 1, wherein the bolt has a bolt head and a bolt shaft which are detachably joined to one another.

5. The lock in accordance with claim 1, wherein the bolt has a bolt head and a bolt shaft which are detachably joined to one another by means of a screw.

6. The lock in accordance with claim 4, wherein the bolt head has a pocket-shaped recess into which an end of the bolt shaft is inserted.

7. The lock in accordance with claim 5, wherein the bolt head has a hole for a screw and wherein an elongated opening is provided in the end of the bolt shaft which has been inserted into the recess, the hole extending on either side of the recess and the hole and the elongated opening being arranged relative to one another such that a screw which has been screwed into the hole penetrates the opening in the bolt shaft.

8. The lock in accordance with claim 7, wherein in the region of the recess in the bolt head there is a fixing element which has at least one wedge-shaped clamping surface and a hole in which the screw engages, and wherein the elongated opening in the bolt shaft has at least one corresponding counter-clamping surface such that, with the screw tightened, the clamping surface and the counter-clamping surface interact such that the bolt head is fixed relative to the bolt shaft while with the screw loosened, the clamping surface and the counter-clamping surface do not interact so that the bolt head is movable relative to the bolt shaft in the direction of movement of the bolt.

9. The lock in accordance with claim 8, wherein the at least one clamping surface of the fixing element has several ribs and on the at least one counter-clamping surface of the elongated opening in the bolt shaft has several ribs.

10. The lock in accordance with claim 1, wherein the housing has at least two slot-shaped attachment openings.

11. The lock in accordance with claim 10, wherein an edge region of the housing which surrounds the attachment openings has several ribs.

12. The lock in accordance with claim 1, wherein the blocking element is pivotally mounted and is driven by an electric motor.

13. The lock in accordance with claim 1, wherein a lever element is pivotably mounted in the housing to pivot around an axis, the bolt being held in the blocking position via the lever element when the lever element adjoins the blocking element.

14. The lock in accordance with claim 1, suitable for use within a scissors bolt mechanism which has two bolts arranged opposite one another, which bolts are movable towards one another for opening of the bolt mechanism, wherein each bevel of the bolt of the lock in the extended blocking position of the lock interacts with a respective one of the bolts of the scissors bolt mechanism.
